(19) United States
(12) Patent Application Publication
(10) Pub. No.: US 2013/0001843 A1
(43) Pub. Date: Jan. 3, 2013

(54) FLUID-FILLED ACTIVE VIBRATION-DAMPING DEVICE

(75) Inventor: Tomohiro KANAYA, Kasugai-shi (JP)

(73) Assignee: TOKAI RUBBER INDUSTRIES, LTD., Aichi (JP)

(21) Appl. No.: 13/534,450

(22) Filed: Jun. 27, 2012

(30) Foreign Application Priority Data
Jun. 30, 2011 (JP) 2011-145052

(51) Int. Cl. F16F 13/26; F16F 13/08

(52) U.S. Cl. 267/140.14

(57) ABSTRACT

A fluid-filled active vibration damping device including a partition member having a holding space formed therein and a movable membrane installed in the holding space. A filter orifice tuned to a higher frequency than an orifice passage is formed at one wall part of the holding space facing to one surface of the movable membrane, and the holding space is in communication with one of a pressure receiving fluid chamber and an excitation fluid chamber through the filter orifice. An open hole is formed on the other wall part of the holding space facing to the other surface of the movable membrane opposite to the one surface in the thickness direction, and the holding space is in communication with the other of the two fluid chambers through the open hole. A through hole pierces the movable membrane in the thickness direction.

### INCORPORATED BY REFERENCE

The disclosure of Japanese Patent Application No. 2011-145052 filed on Jun. 30, 2011 including the specification, drawings and abstract is incorporated herein by reference in its entirety.

### BACKGROUND OF THE INVENTION

1. Field of the Invention

The present invention relates to a fluid-filled vibration damping device used for an automobile engine mount or the like, for example, and particularly relates to a fluid-filled active vibration damping device made to exhibit an active vibration damping effect based on excitation force applied from outside.

2. Description of the Related Art

As one type of vibration damping devices applied for the engine mount of automobiles or the like, for example, fluid-filled vibration damping devices which use the flow action of the fluid enclosed in the interior are known. This fluid-filled vibration damping device has a first mounting member and a second mounting member elastically connected by a main rubber elastic body, and has a constitution whereby a pressure receiving fluid chamber for which a portion of the wall part is constituted with the main rubber elastic body, and an equilibrium fluid chamber for which a portion of the wall part is constituted with a flexible film are in communication with each other through an orifice passage. Furthermore, in Japanese Unexamined Patent Publication No. JP-A-2009-92235 and the like, also proposed are fluid-filled active vibration damping devices made to exhibit active vibration damping effects by applying the excitation force of an electromagnetic actuator or a pneumatic actuator on a fluid chamber. The fluid-filled active vibration damping device is equipped with an excitation fluid chamber in communication with the pressure receiving fluid chamber, whereby a portion of the wall part of the excitation fluid chamber is constituted by an excitation member, and the excitation member is made to undergo excitation displacement by the actuator. Then, the driving force generated by the actuator is applied to the excitation fluid chamber as excitation force and transmitted to the pressure receiving fluid chamber, thereby exhibiting a vibration damping effect that offsets the input vibration.

With the fluid-filled active vibration damping device, when a low frequency, large amplitude vibration such as engine shake or the like is input, the internal pressure fluctuation of the pressure receiving fluid chamber is absorbed by the displacement of the excitation member. As a result, the fluid flow volume through the orifice passage decreases, leading to a problem of deterioration of vibration damping performance. In light of this, the device disclosed in JP-A-2009-92235 is arranged such that: a holding space is provided to a partition member that separates the pressure receiving fluid chamber and the excitation fluid chamber; the holding space is in communication with the pressure receiving fluid chamber and the excitation fluid chamber; and a movable plate for which the deformation is restricted is installed inside the holding space. As a result, when low frequency, high amplitude vibration is input, the movable plate is held in contact with the top and bottom wall parts of the holding space, thereby blocking the communicating hole of the holding space to the pressure receiving fluid chamber and excitation fluid chamber. Therefore, fluid flows through the orifice passage based on pressure fluctuation of the pressure receiving fluid chamber are efficiently brought about without absorption by displacement of the excitation member. In addition, when high frequency, small amplitude vibration is input, the movable plate undergoes minute displacement within the holding space, so that the pressure receiving fluid chamber and the excitation fluid chamber are in communication through the holding space. Thus, an active vibration damping effect is exhibited by the excitation force applied to the excitation fluid chamber being transmitted to the pressure receiving fluid chamber.

However, with the switching mechanism using the movable plate like that disclosed in JP-A-2009-92235, when a rigid movable plate is held in contact with the top and bottom wall parts of the holding space due to large amplitude vibration input and the excitation fluid chamber is sealed, there is the risk that the excitation displacement of the excitation member by the actuator will be hindered by the fluid pressure of the excitation fluid chamber or the like. For that reason, depending on the required characteristics of a vehicle, a constitution may be desired for which a more stable and high level active vibration damping effect can be exhibited.

### SUMMARY OF THE INVENTION

It is therefore one object of this invention to provide a fluid-filled active vibration damping device of a novel constitution for which it is possible to effectively exhibit both a passive vibration damping effect using the orifice passage and an active vibration damping effect using the excitation force applied from outside.

A first mode of the present invention is a fluid-filled active vibration damping device, which comprises: a first mounting member; a second mounting member; a main rubber elastic body elastically connecting the first and second mounting members; a pressure receiving fluid chamber whose wall is partially defined by the main rubber elastic body; an equilibrium fluid chamber whose wall is partially defined by a flexible film; an orifice passage through which the pressure receiving fluid chamber and the equilibrium fluid chamber are held in mutual communication; and an excitation fluid chamber whose wall is partially defined by an excitation member disposed on a side opposite to the pressure receiving fluid chamber, sandwiching a partition member supported by the second mounting member, the excitation member being adapted to be excited by a driving force generated by an actuator supported by the second mounting member so that the driving force of the actuator is applied to the excitation fluid chamber via the excitation member, wherein a holding space is formed inside the partition member and a movable membrane is installed in the holding space with an outer circumference part thereof being supported by the partition member, a filter orifice tuned to a higher frequency than the orifice passage is formed at one wall part of the holding space facing to one surface of the movable membrane, and the holding space is in communication with one of the pressure receiving fluid chamber and the excitation fluid chamber through the filter orifice, an open hole is formed on another wall part of the holding space facing to another surface of the movable membrane opposite to the one surface in the thickness direction, and the holding space is in communication with another of the pressure receiving fluid chamber and the excitation fluid chamber through the open hole, and a through hole that pierces in the thickness direction is formed on the movable membrane.

With a fluid-filled active vibration damping device with this kind of constitution according to the first mode, through hole is formed piercing in the thickness direction on the movable membrane, so when there is displacement of the excitation member due to the actuator, in addition to the minor deformation of the movable membrane, it is possible for there to be a flow of fluid through the through hole between the pressure receiving fluid chamber and the excitation fluid chamber. As a result, the excitation member can easily be displaced without being restrained by the fluid pressure of the excitation fluid chamber, making it possible to ensure a large excitation amplitude, and to effectively obtain the target active vibration damping effect on mid to high frequency input vibration.

Also, when a low frequency, large amplitude vibration is input, the movable membrane is restrained by abutting the wall part of the holding space. This arrangement is effective to prevent transmission of the fluid pressure between the pressure receiving fluid chamber and the excitation fluid chamber by the minor deformation of the movable membrane, and also is effective to induce internal pressure fluctuations of the pressure receiving fluid chamber. Thus, the fluid flow volume through the orifice passage is ensured, and a passive vibration damping effect is effectively exhibited based on the flow action of the fluid.

The second mode of the present invention is a fluid-filled active vibration damping device according to the first mode, wherein the one surface of the movable membrane is separated from and facing to the one wall part of the holding space, and the other surface of the movable membrane is overlapped on the other wall part of the holding space, and a cross sectional area of the open hole is made to be larger than a cross sectional area of the filter orifice.

With the second mode, when the movable membrane is greatly deformed to one side in its thickness direction due to input of a large amplitude vibration, the movable membrane is adhered to the wall part of the holding space, and the filter orifice is blocked by the movable membrane. Also, when attempting to do a large deformation to the other side in the thickness direction of the movable membrane by input of a large amplitude vibration, the movable membrane is restrained by abutting on the opening circumference part of the open hole, and the deformation volume of the movable membrane is restricted. As a result, the fluid flow between the pressure receiving fluid chamber and the excitation fluid chamber is restricted by the movable membrane, making it possible to prevent the pressure of the pressure receiving fluid chamber from being transmitted to the excitation fluid chamber and absorbed by displacement of the excitation member. Therefore, the relative pressure difference of the pressure receiving fluid chamber and the excitation fluid chamber becomes large, and fluid flow volume through the orifice passage is ensured, so it is possible to effectively obtain a vibration damping effect based on the fluid flow action.

Meanwhile, a minute deformation to one side in the thickness direction of the movable membrane is allowed by the space between the facing surfaces of the movable membrane and the holding space wall part, and a minute deformation to the other side in the thickness direction of the movable membrane is allowed by the movable membrane entering the open hole. For that reason, when a high frequency, small amplitude vibration is input, the driving force generated by the actuator is transmitted from the excitation fluid chamber to the pressure receiving fluid chamber even by a minute deformation of the movable membrane. Thus, an active vibration damping action is effectively exhibited based on a vibration offsetting effect or the like.

In particular, the cross sectional area of the open hole is made larger than the cross sectional area of the filter orifice, so that the elastic deformation volume to the open hole side of the movable membrane can be made sufficiently larger, whereby it is possible to obtain a sufficient active vibration damping effect for a small amplitude vibration. For that reason, it is possible to prevent the deformation of the movable membrane from being unnecessarily small, and for the target vibration damping effect to be effectively exhibited.

In fact, in contrast to the movable plate which is freely displaced within the holding space, the movable membrane is made to return to its initial position based on its own elasticity. Then, in its initial position, minute deformation is allowed with the movable membrane by the space between the facing surface with the holding space wall part and the open holes. For that reason, the excitation force applied to the excitation fluid chamber (driving force generated by the actuator) is stably transmitted to the pressure receiving fluid chamber, and the target vibration damping effect is effectively exhibited.

Also, the other surface in the thickness direction of the movable membrane is overlapped on the wall part of the holding space, and minute deformation of the movable membrane is allowed by the open holes. This arrangement, in comparison with a case when the minute deformation of the movable membrane in the thickness direction is allowed in the space between the facing surfaces with the holding space wall part at both sides in the thickness direction, makes it possible for the partition member to make the axial direction dimensions smaller. As a result, it is possible to realize a compact fluid-filled active vibration damping device.

The third mode of the present invention is a fluid-filled active vibration damping device according to the second mode, wherein the excitation fluid chamber and the holding space is in communication through the open hole, the through hole is aligned with the open hole and these are in communication with each other, the excitation member is elastically connected to the second mounting member with a spring member, and the excitation member is arranged to be separated and displaced in relation to the partition member by the driving force generated by the actuator, while being arranged to return to an initial position based on an elasticity of the spring member, by cancellation of the driving force generated by the actuator.

With the third mode, when the excitation member is displaced in the separation direction from the partition member by the driving force generated by the actuator, since the through hole is aligned with the open holes and these are in communication with each other, inflow of fluid is allowed through the through hole from the pressure receiving fluid chamber to the excitation fluid chamber. Thus, the fluid pressure fluctuation of the excitation fluid chamber by displacement of the excitation member is reduced. For that reason, the excitation amplitude of the excitation member is effectively obtained, and the active vibration damping effect is effectively exhibited.

Also, in a state with the movable membrane abutting the wall part of the holding space pressure receiving fluid chamber side, the force based on the fluid pressure of the excitation fluid chamber which acts on the movable membrane through the open hole with a large surface area is dominant compared to the force based on the fluid pressure of the pressure receiving fluid chamber that acts on the movable membrane through the filter orifice with a small surface area. For that reason, the effect of the fluid pressure of the pressure receiving fluid chamber on the excitation displacement of the excitation member is restricted, making it possible to stably obtain the active vibration damping effect.

Also, the fluid pressure absorption based on the elasticity of the spring member, which is likely to occur easily when large amplitude vibration is input, is avoided by restriction of the deformation of the movable membrane by abutting the partition member. For that reason, the vibration damping effect by fluid flow through the orifice passage is effectively exhibited, and it is possible to exhibit excellent vibration damping performance.

The fourth mode of the present invention is a fluid-filled active vibration damping device according to any of the first through third modes, wherein a ratio (A/L) of a path cross sectional area (A) and a path length (L) of the through hole is not less than a ratio of a path cross sectional area and a path length of the filter orifice.

With the fourth mode, a fluid flow through the through hole between the pressure receiving fluid chamber and the excitation fluid chamber is maintained up to the frequency range at which the filter orifice is substantially blocked by anti-resonance, so an active vibration damping effect is more advantageously exhibited.

With the present invention, by forming the through hole piercing in the thickness direction of the movable membrane, when the excitation member is excited by the actuator, in addition to deformation of the movable membrane, fluid flow also occurs between the pressure receiving fluid chamber and the excitation fluid chamber through the through hole. This makes it possible to ease the restraint of the excitation member by the action of the fluid pressure of the excitation fluid chamber. Therefore, it is possible to make the excitation amplitude of the excitation member larger, and to effectively obtain the target active vibration damping effect. In addition, when a large amplitude vibration is input, with restriction of the movable membrane deformation by the holding space wall part, fluid flow volume through the orifice passage is ensured, and a passive vibration damping effect is exhibited based on the fluid flow action.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a vertical cross sectional view showing a fluid-filled active vibration damping device in the form of an engine mount as a first embodiment of the present invention;

FIG. 2 is a plan view of a first bulkhead plate constituting the engine mount shown in FIG. 1;

FIG. 3 is a plan view of a second bulkhead plate constituting the engine mount shown in FIG. 1;

FIG. 4 is a plan view of a movable membrane constituting the engine mount shown in FIG. 1;

FIG. 5 is an exploded perspective view of a partition member constituting the engine mount shown in FIG. 1; and

FIG. 6 is a vertical cross sectional view showing an engine mount as another embodiment of the present invention.

### DETAILED DESCRIPTION OF PREFERRED EMBODIMENTS

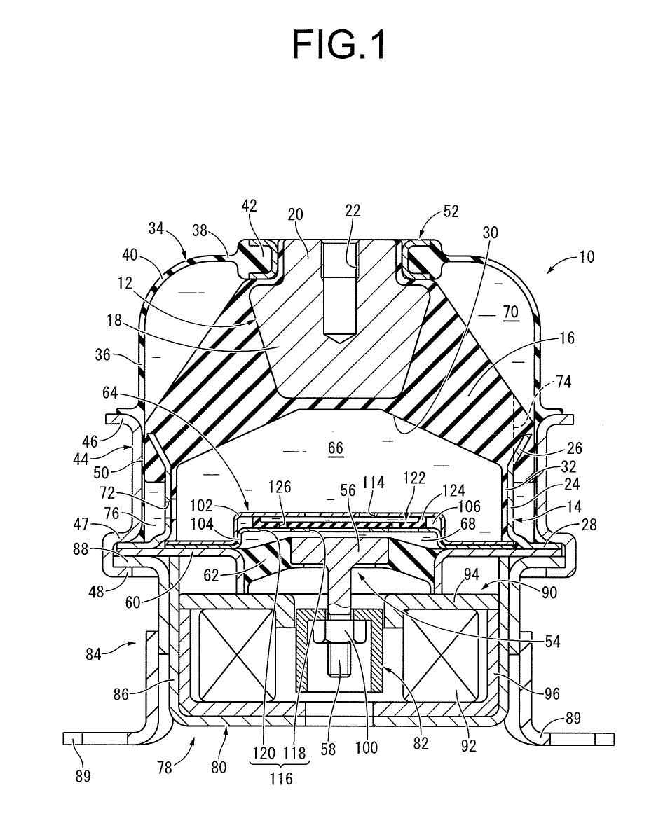

FIG. 1 shows an automobile engine mount 10 as the first embodiment of the fluid-filled active vibration damping device constituted according to the present invention. The engine mount 10 has a constitution for which a first mounting member 12 and a second mounting member 14 are elastically connected by a main rubber elastic body 16, and the first mounting member 12 is attached to a power unit (not shown), and the second mounting member 14 attached to a vehicle body (not shown). With the description below, the up-down direction means the up-down direction in FIG. 1 as a rule.

More specifically, the first mounting member 12 exhibits overall a small diameter, roughly stepped round column shape, and is equipped with a lower fixing part 18 having a reverse direction, roughly truncated cone shape and a round column shaped upper engaging part 20 projecting facing upward with a smaller diameter than the top end part of the lower fixing part 18 as an integrated unit. Furthermore, a bolt hole 22 that extends over the central axis and opens at the top surface is formed on the first mounting member 12, and a screw thread is formed on the inner circumference surface.

The second mounting member 14 has a thin-walled, large diameter ring shape, having an upper end taper part 26 extending out with a gradually expanding diameter facing upward in the axial direction from the top end of a center tube shaped part 24 which has a roughly round cylinder shape, and has a lower end crimping part 28 extending facing outward in the axial perpendicular direction from the lower end.

Then, the first mounting member 12 is arranged on the same center axis above the second mounting member 14, and the first mounting member 12 and the second mounting member 14 are elastically connected by the main rubber elastic body 16. The main rubber elastic body 16 exhibits a thick-walled, large diameter, roughly circular truncated cone shape, and the lower fixing part 18 of the first mounting member 12 is adhered by vulcanization to the small diameter side end part, and also, the upper end taper part 26 of the second mounting member 14 is adhered by vulcanization to the large diameter side end part. The main rubber elastic body 16 is formed as an integral vulcanized molded article equipped with the first mounting member 12 and the second mounting member 14. Also, a rubber layer formed as an integral unit with the main rubber elastic body 16 is adhered by vulcanization on the lower fixing part 18 upper surface and the upper engaging part 20 outer circumference surface of the first mounting member 12.

Furthermore, a large diameter recess 30 is formed on the main rubber elastic body 16. The large diameter recess 30 is a recess that opens toward the large diameter side end surface of the main rubber elastic body 16, and exhibits an opposite facing, roughly mortar shape that is smaller than the inner diameter of the second mounting member 14.

Furthermore, a sealing rubber layer 32 extends downward from the opening circumference edge part of the large diameter recess 30 at the main rubber elastic body 16. The sealing rubber layer 32 is a rubber elastic body exhibiting a thin-walled, large diameter round cylinder shape, and is formed so as to cover the inner circumference surface of the second mounting member 14.

Also, a flexible film 34 is attached to the second mounting member 14. The flexible film 34 forms a ring shape overall, and an outer circumference end cylinder part 36 and an inner circumference end annular disk part 38 are constituted connected by an arc-shaped curved part 40. Furthermore, a ring-shaped fixing part 42 is integrally formed further to the inner circumference side than the annular disk part 38 of the flexible film 34.

Furthermore, an outer circumference fixing member 44 is adhered by vulcanization to the outer circumference end part of the flexible film 34. The outer circumference fixing member 44 exhibits an overall roughly round cylinder shape, and has a flange part 46 provided on the top end part, and also, a cylinder shaped crimping piece 48 is integrally formed via a step part 47 on the bottom end part. Then, the outer circumference end part of the flexible film 34 is adhered by vulcanization to the top end part of the outer circumference fixing member 44 which contains the flange part 46. A covering rubber layer 50 which is integrally formed with the flexible film 34 is formed adhered along roughly the entirety except for the crimping piece 48 on the inner circumference surface of the outer circumference fixing member 44.

Furthermore, an inner circumference fixing member 52 is adhered by vulcanization to the fixing part 42 constituting the inner circumference end part of the flexible film 34. The inner circumference fixing member 52 has an annular ring shape, and has a shape for which the respective end part flanges extend toward the outer circumference side from both ends of the center part which is a round cylinder extending in the axial direction. Then, by having the fixing part 42 adhered by vulcanization to the outer circumference surface of the inner circumference fixing member 52, the flexible film 34 is adhered by vulcanization to the inner circumference fixing member 52. The flexible film 34 is formed as an integral vulcanized molded article equipped with the outer circumference fixing member 44 and the inner circumference fixing member 52.

The flexible film 34 with this kind of constitution has the outer circumference part supported by the second mounting member 14 by the crimping piece 48 of the outer circumference fixing member 44 being fixed by crimping to the lower end crimping part 28 of the second mounting member 14. Furthermore, the flexible film 34 has the inner circumference part attached to the first mounting member 12 by the inner circumference fixing member 52 being fit externally to the upper engaging part 20 of the first mounting member 12.

The center tube shaped part 24 and the upper end taper part 26 of the second mounting member 14 are separated to the inner circumference side along the entire circumference in relation to the outer circumference fixing member 44, and also, the part fixed to the outer circumference surface of the center tube shaped part 24 top end part and upper end taper part 26 of the main rubber elastic body 16 is stuck to the outer circumference fixing member 44 via the covering rubber layer 50. As a result, a ring shaped space is formed between the center tube shaped part 24 and the upper end taper part 26 of the second mounting member 14 on the one hand, and the outer circumference fixing member 44 on the other.

Also, an excitation member 54 is installed on the lower side opening part of the second mounting member 14. The excitation member 54 is equipped as an integral unit with a roughly disk shaped excitation plate part 56 and a connecting rod part 58 extending facing downward at the center axis of the excitation plate part 56.

Also, the excitation member 54 is elastically supported by the second mounting member 14. Specifically, a roughly annular ring shape or circular disk shaped support member 60 is installed separated by a specified distance at the outer circumference side of the excitation member 54, and this support member 60 is fixed to the second mounting member 14 by the crimping piece 48 of the outer circumference fixing member 44. Also, as a spring member, a support rubber elastic body 62 is installed in the radial direction between the support member 60 and the excitation plate part 56. The support rubber elastic body 62 has a roughly annular disk shape tilting down toward the outer circumference side, and the inner circumference surface is adhered by vulcanization to the outer circumference surface of the excitation plate part 56, and also, the outer circumference surface is adhered by vulcanization to the inner circumference surface of the outer circumference fixing member 44. As a result, the excitation plate part 56 of the excitation member 54 and the support member 60 are mutually elastically connected by the support rubber elastic body 62, and the excitation member 54 is elastically supported by the second mounting member 14.

Also, a partition member 64 is installed above the excitation member 54. The partition member 64 overall exhibits a roughly stepped round disk shape for which the center part projects upward, its outer circumference part overlaps the top surface of the support member 60, and is supported by the second mounting member 14, and also, the center part is installed separated by a specified distance above the excitation member 54 and the support rubber elastic body 62.

Then, a pressure receiving fluid chamber 66 for which a portion of the wall part is constituted by the main rubber elastic body 16, and for which internal pressure fluctuations are brought about when vibration is input is formed on the top side sandwiching the partition member 64, and also, an excitation fluid chamber 68 for which a portion of the wall part is constituted by the excitation member 54 is formed on the bottom side sandwiching the partition member 64. In other words, the excitation fluid chamber 68 is provided on the opposite side to the pressure receiving fluid chamber 66 sandwiching the partition member 64.

Furthermore, an equilibrium fluid chamber 70 which allows capacity changes is formed on the opposite side to the pressure receiving fluid chamber 66 (outer circumference side of the main rubber elastic body 16) sandwiching the main rubber elastic body 16 with a portion of the wall part constituted by the flexible film 34. An incompressible fluid is enclosed in all of the pressure receiving fluid chamber 66, the excitation fluid chamber 68, and the equilibrium fluid chamber 70. This incompressible fluid is not particularly limited, but for example water, alkylene glycol, polyalkylene glycol, silicone oil, or mixed solutions of these or the like can be suitably used. Furthermore, to advantageously obtain the vibration damping effect based on the fluid flow action described later, it is preferable to use as the enclosed fluid a fluid of a low viscosity of 0.1 Pa·s or lower.

Also, the ring shaped space formed between the second mounting member 14 and the outer circumference fixing member 44 communicates with the pressure receiving fluid chamber 66 through a first connection hole 72 pierced in the radial direction of the center tube shaped part 24 of the second mounting member 14 and the sealing rubber layer 32, and also, communicates with the equilibrium fluid chamber 70 through a second connection hole 74 piercing the upper end taper part 26 of the second mounting member 14 and the main rubber elastic body 16. As a result, an orifice passage 76 is formed by which the pressure receiving fluid chamber 66 and the equilibrium fluid chamber 70 mutually communicate. This orifice passage 76, by adjusting the ratio of the path cross sectional area (A) and the path length (L) taking into consideration wall spring rigidity, has the tuning frequency set to approximately 10 Hz which correlates to engine shake. The ring shaped space formed between the second mounting member 14 and the outer circumference fixing member 44 is sectioned to a length slightly shorter than one circumference by a bulkhead (not shown) formed as an integral unit with the main rubber elastic body 16 being provided on part of the circumference.

Meanwhile, an actuator 78 is installed below the excitation member 54. The actuator 78 is a so-called electromagnetic actuator equipped with a stator 80 supported by the second mounting member 14, and a mover 82 which is allowed relative displacement in the axial direction in relation to the stator 80.

The stator 80 is equipped with a housing 84 fixed by crimping to the second mounting member 14 by the crimping piece 48 of the outer circumference fixing member 44. The housing 84 is equipped with a housing main unit 86 of a roughly round cylinder shape with a bottom for which a round through hole is formed at the center of the bottom wall part, and a flange type attachment part 88 exhibiting a hook shaped cross section. Furthermore, a plurality of leg parts 89 are fixed to the outside of the attachment part 88. The through hole formed at the center of the bottom wall part of the housing main unit 86 can also be blocked with the object of preventing infiltration by foreign matter or the like.

A coil member 90 is also attached to the housing 84. The coil member 90 is formed by an upper yoke 94 being overlapped on the top surface and the inner circumference surface top part of a coil 92 exhibiting a round cylinder shape, as well as by a lower yoke 96 being overlapped on the outer circumference surface and lower surface of the coil 92. The upper yoke 94 and the lower yoke 96 are both formed using ferromagnetic materials, and a magnetic path is made to be formed when energy is conducted to the coil 92. Also, the inner circumference end part of the upper yoke 94 and the inner circumference end part of the lower yoke 96 are separated vertically, and when energy is conducted to the coil 92, a magnetic gap occurs between the inner circumference end parts of the upper and lower yokes 94 and 96, and mutually different magnetic poles are made to be formed at the inner circumference end part of the upper yoke 94 and the inner circumference end part of the lower yoke 96. Then, the coil member 90 is fixed to the housing 84 by the upper yoke 94 being engaged with the peripheral wall part of the housing main unit 86, and the lower yoke 96 being fit overlapping with the housing main unit 86 peripheral wall part and lower wall part.

Also, the mover 82 is inserted in the center hole of the coil member 90. The mover 82 is formed with a ferromagnetic body exhibiting a reverse direction, roughly round cylinder shape with a bottom, and a circular through hole is formed in the center part of the upper bottom wall part. This mover 82 has its upper end positioned higher than the inner circumference end part lower surface of the upper yoke 94, and the lower end is positioned higher than the upper surface of the inner circumference end part of the lower yoke 96.

Then, by electricity being supplied to the coil 92 from an external power supply (not shown), magnetic poles are respectively formed at the inner circumference end parts of the upper and lower yokes 94 and 96, and the mover 82 is pulled downward by magnetic force.

The actuator 78 constituted in this way is supported by the second mounting member 14. Specifically, by the attachment part 88 of the housing 84 being fixed by crimping by the crimping piece 48 of the outer circumference fixing member 44, the stator 80 is attached to the second mounting member 14.

Meanwhile, the mover 82 of the actuator 78 is attached to the excitation member 54. Specifically, the connecting rod part 58 of the excitation member 54 is inserted through the mover 82, and by having the upper bottom wall part of the mover 82 engaged in the axial direction in relation to a nut 100 screwed into the lower edge part of the connecting rod part 58, the mover 82 is retained by and attached to the connecting rod part 58 of the excitation member 54. For example, as noted in U.S. Pat. No. 7,188,830, it is also possible to have an energization means such as a coil spring or the like installed between the facing surfaces in the axial direction of the excitation plate part 56 and the mover 82, and by the mover 82 being energized downward in relation to the excitation member 54, to have the mover 82 pressed against the nut 100, to prevent loosening of the nut 100.

Then, with the actuator 78, when the mover 82 is pulled downward and displaced in the axial direction in relation to the stator 80 by electricity being supplied to the coil 92, the excitation member 54 is displaced downward together with the mover 82 by the latching of the mover 82 and the nut 100. After that, when supplying of electricity to the coil 92 is stopped, since the magnetic pulling force acting on the mover 82 is cancelled, by the restoring force based on the elasticity of the support rubber elastic body 62, the excitation member 54 returns to its initial position. By repeating the action noted above at specified cycles, the excitation member 54 undergoes vertical excitation displacement at the target frequency, and the driving force generated by the actuator 78 is applied to the excitation fluid chamber 68 as the excitation force. At the time the excitation member 54 returns to its initial position, the mover 82 also returns to the initial position together with the excitation member 54.

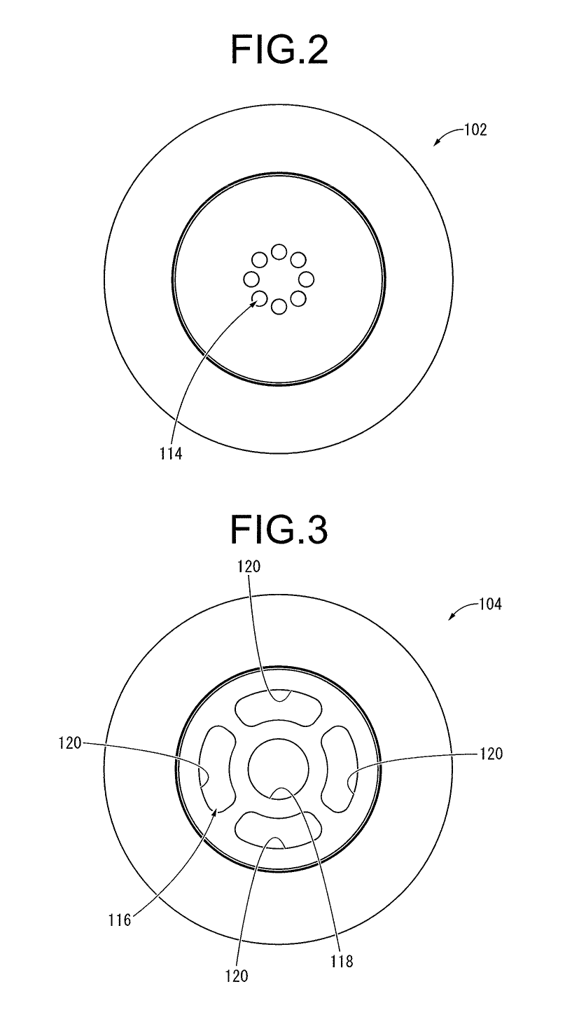

Also, the pressure receiving fluid chamber 66 and the excitation fluid chamber 68 are in communication with each other through the fluid flow path provided on the partition member 64. In more detail, the partition member 64 is constituted including a first bulkhead plate 102 and a second bulkhead plate 104. As shown in FIG. 1 and FIG. 2, the first bulkhead plate 102 has a roughly stepped, round disk shape (hat shape) for which the center part projects upward. On the other hand, as shown in FIG. 1 and FIG. 3, the second bulkhead plate 104 has a roughly stepped, round disk shape (hat shape) for which the center part projects upward the same as the first bulkhead plate 102, while the projecting height of the center part is smaller than that of the first bulkhead plate 102, and also, the step part is positioned further to the inner circumference than the first bulkhead plate 102. The first bulkhead plate 102 and the second bulkhead plate 104 are formed by a plate material of roughly the same thickness dimensions to each other, and for example can be obtained by press working.

Then, the first bulkhead plate 102 overlaps the second bulkhead plate 104 from above, and the step part of the first bulkhead plate 102 is fit externally on the step part of the second bulkhead plate 104. In a state with the first bulkhead plate 102 and the second bulkhead plate 104 assembled, the center part of the first bulkhead plate 102 and the center part of the second bulkhead plate 104 are arranged separated in the axial direction and facing opposite. As a result, using the area between opposite facing surfaces in the axial direction of the first bulkhead plate 102 and the second bulkhead plate 104, a holding space 106 is formed inside the partition member 64. This holding space 106 is an area exhibiting a roughly cylindrical shape or a thick-walled, round disk shape, and the top side wall part is constituted by the center part of the first bulkhead plate 102, and also, the bottom side wall part is constituted by the center part of the second bulkhead plate 104.

Also, on the axial direction top side wall part of the holding space 106 is formed a filter orifice 114. As shown in FIG. 2, the filter orifice 114 is a hole formed on the center part of the first bulkhead plate 102 constituting the top side wall part of the holding space 106, and is constituted by eight circular holes piercing in the axial direction provided at equal intervals on the circumference. Also, with this filter orifice 114, the ratio of the path cross sectional area and the path length is greater than the ratio of the orifice passage 76 path cross sectional area and path length, and is tuned to a higher frequency than the orifice passage 76. The filter orifice 114 has the tuning frequency set according to the frequency of the vibration to undergo vibration damping by the active vibration damping effect described later, and for example is tuned to a medium frequency of approximately ten or more Hz correlating to idling vibration, or to a high frequency band of approximately several tens of Hz correlating to running muffled sound.

Also, an open hole 116 is formed on the axial direction bottom side wall part of the holding space 106. As shown in FIG. 3, the open hole 116 is a hole provided on the center part constituting the bottom side wall part of the holding space 106 on the second bulkhead plate 104, and is constituted by a center open hole 118 piercing the radial direction center in the axial direction, and four outer circumference open holes 120 piercing in the axial direction formed on the periphery thereof. The center open hole 118 has a circular horizontal cross section of a larger diameter than the circular hole constituting the filter orifice 114 and is formed piercing in the axial direction on the center axis. The outer circumference open holes 120 have a horizontal cross section shape extending at a designated length in the circumference direction, and are formed piercing in the axial direction on the center part of the second bulkhead plate 104 at a position separated from the center open hole 118 to the outer the circumference side.

Furthermore, the open hole 116 is formed with a larger cross sectional area than the filter orifice 114. Specifically, with this embodiment, the total cross sectional area of the center open hole 118 and the four outer circumference open holes 120 is greater than the cross sectional area of the filter orifice 114 constituted by eight circular holes. Furthermore, the cross sectional area of the center open hole 118 and the cross sectional area of all the outer circumference open holes 120 is greater than the cross sectional area of all the circular holes constituting the filter orifice 114. In addition, the filter orifice 114 forming part at the first bulkhead plate 102 and the open hole 116 forming part at the second bulkhead plate 104 have roughly the same thickness in the axial direction, and the resonance frequency of the fluid flowing through the open hole 116 is set to a higher frequency than the tuning frequency of the filter orifice 114. When the cross sectional area of the open hole 116 and the filter orifice 114 changes in the length direction, this means the minimum value of the cross sectional areas thereof.

Then, the holding space 106 is in communication with the pressure receiving fluid chamber 66 through the filter orifice 114 formed on one (top side) wall part in the axial direction, and also, is in communication with the excitation fluid chamber 68 through the open hole 116 formed on the other (bottom side) wall part in the axial direction.

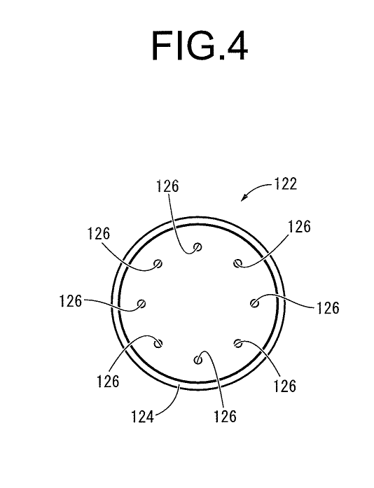

Also, a movable membrane 122 is formed on the holding space 106. As shown in FIGS. 1 and 4, the movable membrane 122 is a rubber elastic body exhibiting a roughly round disk shape, and is formed with outer diameter dimensions smaller than the inner diameter dimensions of the holding space 106. Also, on the outer circumference end part of the movable membrane 122, a ring shaped grasping part 124 is formed as an integral unit so as to project upward, and the outer circumference end part is thick-walled in the axial direction.

Furthermore, on the movable membrane 122, a plurality of through holes 126 are formed further to the inner circumference side than the grasping part 124. These through holes 126 are small diameter circular holes piercing in the thickness direction (vertical direction), and eight of these are formed on the circumference. With this embodiment, the ratio of the path cross sectional area and the path length with the through holes 126 is smaller than the ratio of the path cross sectional area and the path length with the filter orifice 114 described later, and the resonance frequency of the fluid flowing through the through holes 126 is set to a lower frequency than the resonance frequency (tuning frequency) of the fluid flowing through the filter orifice 114.

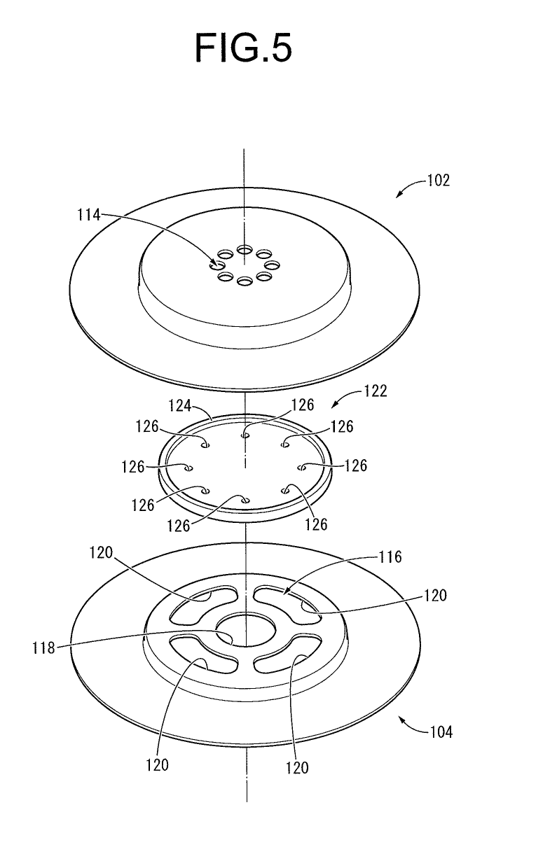

As shown in FIGS. 1 and 5, the movable membrane 122 constituted in this way is sandwiched in the axial direction by the grasping part 124 between the facing surfaces of the first bulkhead plate 102 and the second bulkhead plate 104, and is installed so as to expand in the axis perpendicular direction within the holding space 106. As a result, on one surface (top surface) in the thickness direction of the movable membrane 122, the pressure of the pressure receiving fluid chamber 66 is applied through the filter orifice 114, and on the other thickness direction surface (bottom surface) of the movable membrane 122, pressure of the excitation fluid chamber 68 is applied through the open hole 116. The movable membrane 122 has its outer circumference part fixed and supported by the partition member 64, and also, its center part allows elastic deformation in the axial direction (thickness direction).

Also, one surface (top surface) of the thickness direction of the movable membrane 122 is separated downward and facing opposite in the axial direction in relation to one wall part in the axial direction of the holding space 106 (top side wall part constituted by the first bulkhead plate 102). Furthermore, the other surface (bottom surface) in the thickness direction of the movable membrane 122 is abutting and overlapping across roughly the entire surface in relation to the other wall part (bottom wall part constituted by the second bulkhead plate 104) in the axial direction of the holding space 106 constituted by the second bulkhead plate 104. As a result, in a still state without outside forces acting, the filter orifice 114 is in communication with both the pressure receiving fluid chamber 66 and the holding space 106, and also, the opening part of the holding space 106 side of the open hole 116 is covered by the movable membrane 122.

Furthermore, at least one of the through holes 126 formed on the movable membrane 122 is aligned with the open hole 116, and is serially in communication with the open hole 116. As a result, in a still state, the holding space 106 and the excitation fluid chamber 68 are mutually in communication through the through holes 126, and the fluid flow path by which the pressure receiving fluid chamber 66 and the excitation fluid chamber 68 communicate with each other is formed include the filter orifice 114, the open hole 116, the holding space 106, and the through holes 126. With this embodiment, of the eight through holes 126, every alternate four through holes 126 are aligned and arranged on the open hole 116. Also, the grasping part 124 formed at the outer circumference end part of the movable membrane 122 is positioned separated further to the outer circumference side than the outer circumference open holes 120, and is grasped between the first bulkhead plate 102 and the second bulkhead plate 104 along the entire circumference.

Also, the movable membrane 122 allows a certain degree of elastic deformation in the thickness direction. Specifically, the movable membrane 122 is installed separated downward in the axial direction in relation to the first bulkhead plate 102 constituting the top side inner surface of the holding space 106, and the elastic deformation upward in the thickness direction is allowed in the amount of the distance from the facing surface of the first bulkhead plate 102. Meanwhile, the open hole 116 covered by the movable membrane 122 is formed with a larger cross sectional area than the filter orifice 114, and elastic deformation downward in the thickness direction of the movable membrane 122 is allowed to a certain degree through the open hole 116.

In particular, the cross sectional area of the center open hole 118 and the cross sectional area of each outer circumference open hole 120 are all greater than the cross sectional area of each circular hole constituting the filter orifice 114, so the downward elastic deformation of the movable membrane 122 is allowed by the amplitude needed in accordance with the open hole 116.

The center open hole 118 and the outer circumference outer hole 120 both have their maximum dimension from the surface area center in plan view preferably set to 10× or less in relation to the minimum dimension. As a result, it is possible to ensure a large free length from the open circumference edge part of the center open hole 118 or the outer circumference open hole 120, and downward elastic deformation of the movable membrane 122 is efficiently allowed.

Meanwhile, with the movable membrane 122, excessive elastic deformation in the thickness direction is restricted. Specifically, the elastic deformation upward in the thickness direction of the movable membrane 122 is restricted by abutting the first bulkhead plate 102, and also, the elastic deformation downward in the thickness direction of the movable membrane 122 is restricted by abutting the opening circumference edge part of the open hole 116.

The elastic deformation volume of the movable membrane 122 as described above can be adjusted using the distance between facing surfaces of the movable membrane 122 and the first bulkhead plate 102, and the cross sectional area and opening shape of the open hole 116. Specifically, the elastic deformation volume allowed for the movable membrane 122 becomes larger in accordance with the distance between facing surfaces of the movable membrane 122 and the first bulkhead plate 102 becoming larger, as well as the cross sectional area of the open hole 116 and the minimum dimension from the surface area center at the opening of the open hole 116 becoming larger.

With the engine mount 10 with such a constitution, using brackets or the like (not shown), the first mounting member 12 is attached to a power unit (not shown), and also, the second mounting member 14 is attached to a vehicle body (not shown) by the housing 84 of the actuator 78 being fixed by bolts to the vehicle body at the leg part 89. As a result, the engine mount 10 is mounted on the vehicle, and the power unit is supported with vibration damping by the vehicle body.

In the state with the engine mount 10 mounted on the vehicle, when low frequency, large amplitude vibration correlating to engine shake is input between the first mounting member 12 and the second mounting member 14, fluid flow is made to occur through the orifice passage 76 based on the relative pressure fluctuation of the pressure receiving fluid chamber 66 and the equilibrium fluid chamber 70. As a result, a vibration damping effect (high damping) based on the fluid flow action is exhibited.

At that time, the movable membrane 122 has its deformation restricted by abutting the first and second bulkhead plates 102 and 104, so the fluid pressure absorption action is inhibited. Specifically, when positive pressure is generated at the pressure receiving fluid chamber 66 by input of a low frequency, high amplitude vibration, the movable membrane 122 is made to deform being convex downward through the open hole 116 based on the relative pressure difference of the pressure receiving fluid chamber 66 and the excitation fluid chamber 68, but this is allowed by an insufficient displacement volume in relation to the amplitude of the input vibration, and the movable membrane 122 has its deformation restricted by abutting the opening circumference edge part of the open hole 116. As a result, it is possible to prevent the fluid pressure of the pressure receiving fluid chamber 66 from being transmitted to the excitation fluid chamber 68 and absorbed by deformation of the support rubber elastic body 62. For that reason, internal pressure fluctuation of the pressure receiving fluid chamber 66 is brought about efficiently, and by sufficiently ensuring the fluid flow volume through the orifice passage 76 between the pressure receiving fluid chamber 66 and the equilibrium fluid chamber 70, a vibration damping effect is effectively exhibited based on the fluid flow action.

Furthermore, when negative pressure is generated in the pressure receiving fluid chamber 66 by input of low frequency, large amplitude vibration, the movable membrane 122 is stuck from below to the first bulkhead plate 102 so its deformation is restrained. As a result, exhibiting of the fluid pressure absorption action by elastic deformation of the movable membrane 122 is prevented, and the internal pressure fluctuation of the pressure receiving fluid chamber 66 is ensured without escaping to the excitation fluid chamber 68. With this embodiment, the capacity of the holding space 106 in the state with the movable membrane 122 installed (the capacity of the area higher than the movable membrane 122 in the holding space 106) is smaller than the product of the effective piston surface area and the amplitude of the input vibration during input of low frequency, large amplitude vibration (volume capacity of the fluid flowing to the pressure receiving fluid chamber 66 in accordance with the elastic deformation of the main rubber elastic body 16). For that reason, the movable membrane 122 is stuck to the first bulkhead plate 102 during input of the low frequency, large amplitude vibration.

Furthermore, the filter orifice 114 formed on the first bulkhead plate 102 has a cross sectional area smaller than that of the open hole 116, so deformation of the movable membrane 122 entering the filter orifice 114 is promptly restricted by abutting of the movable membrane 122 in relation to the opening circumference edge part of the filter orifice 114. In fact, the movable membrane 122 has large deformation up to abutting on the first bulkhead plate 102, and it is difficult for deformation that enters the filter orifice 114 which has a small cross section surface area to occur. For that reason, escaping of the fluid pressure due to elastic deformation of the movable membrane 122 entering the filter orifice 114 essentially does not become a problem.

Also, when medium to high frequency, small amplitude vibration correlating to idling vibration is input between the first mounting member 12 and the second mounting member 14, the actuator 78 generates a driving force generated at a frequency according to the input vibration, and the excitation member 54 undergoes excitation displacement in the axial direction. Then, the excitation force applied to the excitation fluid chamber 68 by the excitation displacement of the excitation member 54 is transmitted to the pressure receiving fluid chamber 66 from the excitation fluid chamber 68 by the fluid flow through the through holes 126 of the movable membrane 122.

Specifically, a fluid flow path by which the pressure receiving fluid chamber 66 and the excitation fluid chamber 68 communicate with each other is formed between the pressure receiving fluid chamber 66 and the excitation fluid chamber 68 by the filter orifice 114 and the open hole 116 formed on the partition member 64, the holding space 106, and the through holes 126 formed on the movable membrane 122. Then, when the excitation member 54 is excited by the actuator 78, a relative pressure difference occurs between the pressure receiving fluid chamber 66 and the excitation fluid chamber 68, so fluid flow occurs between the pressure receiving fluid chamber 66 and the excitation fluid chamber 68 through the aforementioned fluid flow path. With this fluid flow, the active excitation force applied to the excitation fluid chamber 68 is transmitted to the pressure receiving fluid chamber 66, and the input vibration is offset and reduced by the active excitation force.

In fact, in a still state, the through holes 126 formed on the movable membrane 122 are aligned relative to the open hole 116 and put into communication, and by being separated downward in the axial direction in relation to the filter orifice 114 are in communication via the holding space 106. For that reason, when the excitation member 54 is displaced downward by the driving force generated by the actuator 78, fluid flow occurs through the through holes 126 (fluid flow path), and the fluid within the pressure receiving fluid chamber 66 flows into the excitation fluid chamber 68. As a result, the decrease of fluid pressure within the excitation fluid chamber 68 by displacement of the excitation member 54 is inhibited, and restraining of the excitation member 54 due to the negative pressure action is reduced or avoided, so the excitation member 54 is easily displaced downward by the driving force generated by the actuator 78. Therefore, a large excitation amplitude of the excitation member 54 is ensured, and it is possible to effectively obtain the target active vibration damping effect.

Also, the excitation force applied to the excitation fluid chamber 68 is transmitted to the pressure receiving fluid chamber 66, by, in addition to the fluid flow through the through holes 126, the elastic deformation of the movable membrane 122 as well. Specifically, the excitation member 54 is excited by the driving force generated by the actuator 78, and when the excitation force is applied to the excitation fluid chamber 68, minute deformation of the movable membrane 122 occurs in the thickness direction according to the excitation force frequency and amplitude. This minute deformation of the movable membrane 122 is allowed by installing the movable membrane 122 separated from the first bulkhead plate 102 at one side in the thickness direction, and also, is allowed by the movable membrane 122 being deformed so as to enter the open hole 116 formed with a cross sectional area larger than the filter orifice 114 at the other side in the thickness direction. As a result, the excitation force applied to the excitation fluid chamber 68 is transmitted to the pressure receiving fluid chamber 66 by the minute deformation of the movable membrane 122 in the thickness direction. Thus, vibration damping effect that offsets the input vibration is effectively exhibited.

In fact, since the filter orifice 114 is provided on the active excitation force transmission path from the excitation fluid chamber 68 to the pressure receiving fluid chamber 66, adverse effects due to higher harmonic waves on the vibration state and the like are prevented, and the active vibration damping effect on the input vibration is more effectively exhibited.

Furthermore, since the cross sectional area of the open hole 116 is larger than the cross sectional area of the filter orifice 114, the downward force on the movable membrane 122 based on the fluid pressure of the excitation fluid chamber 68 acts more dominantly than the upward force based on the fluid pressure of the pressure receiving fluid chamber 66. For that reason, even when the excitation member 54 is drawn downward in a state with the movable membrane 122 stuck to the first bulkhead plate 102, the movable membrane 122 is separated promptly from the first bulkhead plate 102, and is deformed downward following the displacement of the excitation member 54. As a result, when the excitation member 54 returns to the initial center position based on the elasticity of the support rubber elastic body 62, a space is formed between facing surfaces of the movable membrane 122 and the first bulkhead plate 102, and the movable membrane 122 is deformed upward following the displacement of the excitation member 54. In this way, with the engine mount 10, it is possible to avoid obstruction of the transmission of the excitation force by maintaining a state with the movable membrane 122 stuck to the first bulkhead plate 102, and the excitation force is stably transmitted to the pressure receiving fluid chamber 66.

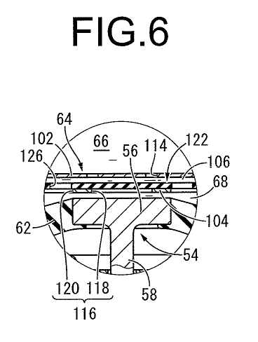

Above, we described in detail an embodiment of the present invention, but the present invention is not limited to the specific description. For example, with this embodiment, the ratio (A/L) of the through hole 126 cross sectional area (A) and length (L) was made to be smaller than the ratio of the cross sectional area and length of the filter orifice 114, but as shown in FIG. 6, it is also possible to make the ratio of the cross sectional area and length of the through holes 126 be larger than the ratio of the cross sectional area and length of the filter orifice 114. By doing this, the resonance frequency of the fluid flowing through the through holes 126 is a higher frequency than the resonance frequency (tuning frequency) of the fluid flowing through the filter orifice 114, so the substantial communicating state of the through holes 126 is maintained up to the frequency range at which the filter orifice 114 is substantially blocked by anti-resonance or the like. As a result, the fluid flow through the through holes 126 between the pressure receiving fluid chamber 66 and the excitation fluid chamber 68 is effectively generated, and it is possible to effectively obtain the target active vibration damping effect. Of course, when the frequency range at which the active vibration damping effect is required is a lower frequency than the frequency range at which the filter orifice 114 is substantially blocked, as with the embodiment noted above, even when the ratio of the cross sectional area and length of the through holes 126 is made lower than the ratio of the cross sectional area and length of the filter orifice 114, it is possible to effectively obtain the target active vibration damping effect.

Also, with the movable membrane 122, the surfaces in the thickness direction do not absolutely have to be overlapped on the inner surface of the holding space 106, and it is also possible to have both surfaces in the thickness direction of the movable membrane 122 be arranged facing the inner surface of the holding space 106 separated by a designated distance. In this case, the through holes 126 formed on the movable membrane 122 do not necessarily have to be aligned with the open hole 116 and the filter orifice 114. Also, the movable membrane 122 can have one surface of the thickness direction overlapped on the inner surface of the holding space 106, and be installed so as to cover the opening of the filter orifice 114, and in this case, the through holes 126 are aligned in relation to the filter orifice 114 so as to be in communication serially.

Also, the filter orifice 114 can be formed so as to communicate with the excitation fluid chamber 68 and the holding space 106, and also, the open hole 116 can be formed so as to communicate with the pressure receiving fluid chamber 66 and the holding space 106.

Also, the shape, number, and formation position and the like of the holes constituting the filter orifice 114 are nothing more than examples, and these are not limited to the embodiment noted above. Similarly, the shape, number, formation position and the like of the holes constituting the open hole 116 (the center open hole 118 and the outer circumference open holes 120 of the embodiment noted above) are also not to be interpreted as being limited.

Also, as the actuator, as an alternative to the electromagnetic actuator shown with the embodiment noted above, it is also possible to use a pneumatic actuator or the like using suction force or the like due to negative pressure.

Also, the application scope of the present invention is not limited to being for an automobile fluid-filled active vibration damping device, but for example can also be applied to a fluid-filled active vibration damping device used for motorcycles, railway vehicles, industrial vehicles or the like. Furthermore, the fluid-filled active vibration damping device of the present invention is not used only as an engine mount, but can also be used as a subframe mount, a body mount, a diff mount or the like.

What is claimed is:

1. A fluid-filled active vibration damping device comprising:
a first mounting member;
a second mounting member;
a main rubber elastic body elastically connecting the first and second mounting members;
a pressure receiving fluid chamber whose wall is partially defined by the main rubber elastic body;
an equilibrium fluid chamber whose wall is partially defined by a flexible film;
an orifice passage through which the pressure receiving fluid chamber and the equilibrium fluid chamber are held in mutual communication; and
an excitation fluid chamber whose wall is partially defined by an excitation member disposed on a side opposite to the pressure receiving fluid chamber, sandwiching a partition member supported by the second mounting member, the excitation member being adapted to be excited by a driving force generated by an actuator supported by the second mounting member so that the driving force of the actuator is applied to the excitation fluid chamber via the excitation member,
wherein a holding space is formed inside the partition member and a movable membrane is installed in the holding space with an outer circumference part thereof being supported by the partition member,
a filter orifice tuned to a higher frequency than the orifice passage is formed at one wall part of the holding space facing to one surface of the movable membrane, and the holding space is in communication with one of the pressure receiving fluid chamber and the excitation fluid chamber through the filter orifice,
an open hole is formed on another wall part of the holding space facing to another surface of the movable membrane opposite to the one surface in the thickness direction, and the holding space is in communication with another of the pressure receiving fluid chamber and the excitation fluid chamber through the open hole, and
a through hole that pierces in the thickness direction is formed on the movable membrane.

2. The fluid-filled active vibration damping device according to claim 1, wherein the one surface of the movable membrane is separated from and facing to the one wall part of the holding space, and the other surface of the movable membrane is overlapped on the other wall part of the holding space, and a cross sectional area of the open hole is made to be larger than a cross sectional area of the filter orifice.

3. The fluid-filled active vibration damping device according to claim 2, wherein the excitation fluid chamber and the holding space is in communication through the open hole, the through hole is aligned with the open hole and these are in communication with each other, the excitation member is elastically connected to the second mounting member with a spring member, and the excitation member is arranged to be separated and displaced in relation to the partition member by the driving force generated by the actuator, while being arranged to return to an initial position based on an elasticity of the spring member, by cancellation of the driving force generated by the actuator.

4. The fluid-filled active vibration damping device according to claim 1, wherein a ratio (A/L) of a path cross sectional area (A) and a path length (L) of the through hole is not less than a ratio of a path cross sectional area and a path length of the filter orifice.
